(19) United States
(12) Patent Application Publication
(10) Pub. No.: US 2007/0230941 A1
(43) Pub. Date: Oct. 4, 2007

(54) Device and method for detecting ambient light

(76) Inventors: Alton Smith, Woodstock, GA (US); Hayden Eastman, Duluth, GA (US)

Correspondence Address: FAY KAPLUN & MARCIN, LLP, 15O BROADWAY, SUITE 702, NEW YORK, NY, 10038, US

(21) Appl. No.: 11/392,443

(22) Filed: Mar. 29, 2006

(51) Int. Cl. G03B 7/00

(52) U.S. Cl. 396/213

(57) ABSTRACT

Described are a device and method for detecting ambient light. The device comprises a processing unit, a memory arrangement and a camera port. The memory arrangement stores setting data which includes a plurality of ambient light levels and a setting of a component of the device corresponding to each level. The camera port is configured to receive first data in a first format from a camera-type arrangement. When the camera port receives from a non-camera type data acquisition device second data in a second format, the processing unit converts the second data into further second data stored in the first format. The processing unit determines an ambient light level as a function of the further second data and adjusts the setting of the component as a function of the ambient light level and the setting data.

### FIELD OF THE INVENTION

The present invention generally relates to systems and methods for detecting ambient light.

### BACKGROUND INFORMATION

Conventional computing devices typically include features and/or settings which facilitate use in varying environments. For example, a hand-held device allows a user to vary a brightness setting of a display screen and keypad when, for example, the device is used in a poorly lit environment. For example, in the poorly lit environment, the brightness setting may be set to a maximum level so the user can view content on the screen and alphanumeric characters on the keypad. When using the device in a well-lit environment, the user may manually adjust the brightness setting to a reduced level. However, manual adjustment may be difficult for untrained personnel and may become a nuisance to the user. Thus, the brightness setting is typically initialized (i.e., defaulted) to the maximum level so that the device is easily usable in the poorly lit environment as well as the well-lit environment without. However, using the maximum level in the well-lit environment unnecessarily drains a power source of the device.

### SUMMARY OF THE INVENTION

The present invention relates to a device and method for detecting ambient light. The device comprises a processing unit, a memory arrangement and a camera port. The memory arrangement stores setting data which includes a plurality of ambient light levels and a setting of a component of the device corresponding to each level. The camera port is configured to receive first data in a first format from a camera-type arrangement. When the camera port receives from a non-camera type data acquisition device second data in a second format, the processing unit converts the second data into further second data stored in the first format. The processing unit determines an ambient light level as a function of the further second data and adjusts the setting of the component as a function of the ambient light level and the setting data.

### BRIEF DESCRIPTION OF THE DRAWINGS

FIG. 1 shows an exemplary embodiment of an electronic device according to the present invention;

FIG. 2 shows an exemplary embodiment of a connection between a data acquisition device and a camera port according to the present invention;

FIG. 3 shows a further embodiment of a connection between the data acquisition device and the camera port of the present invention;

FIG. 4 shows a software task according to the present invention; and

FIG. 5 shows an exemplary embodiment of a method according to the present invention.

### DETAILED DESCRIPTION

The present invention may be further understood with reference to the following description and the appended drawings, wherein like elements are referred to with the same reference numerals. Modern developments in electronics have brought to the market a wide range of electronic devices that can perform many functions. For example, electronic computers have been incorporated with additional functionalities, such as the ability to connect without wires to a computer network. Access to the Internet, to local networks, to private networks and to a variety of other sources of data may be achieved without tying the device to data cables.

These devices have found extensive use as consumer electronics (e.g., for shopping assistance) and as work tools (e.g., for performing business functions). For example, a barcode scanner may be incorporated with a portable electronic processor, which provides the ability to manipulate data on the spot, and to connect with a remote database.

FIG. 1 shows an exemplary embodiment of an electronic device 100 with a processing unit according to the present invention. The device 100 may be an original equipment manufacturer (OEM) product such as, for example, an imager-/laser-based scanner, an RFID reader, a hand-held computer, a mobile phone, a PDA, a diagnostic device, a medical instrument, a component of an automated system, etc. The device 100 may operate with a system-on-chip (SoC) computing architecture so that a chip 110 holds all the necessary hardware and electronic circuitry to maintain operation of the device 100.

The device 100 also provides a user interface which may include a display screen 122, a keypad 124, a microphone, a speaker, etc. To facilitate use in poorly lit environments, the device 100 may utilize a backlight 126 disposed internal to the keypad 124 so that, when activated, it illuminates the keypad 124. In addition, the screen 122 (e.g., an LCD) may utilize a variable brightness setting which may be adjusted based on an ambient light level determined from data acquired the device 100, as will be described further below.

The chip 110 may contain a set of components similar to those utilized in typical devices. For example, the chip 110 may include an on-chip memory 120 (RAM and ROM) storing data and instructions for analyzing the data, a microprocessor 130, a peripheral interface 140, an I/O logic control 150, a data converter 160 and any other component that would complete the SoC. As would be understood by those skilled in the art, the chip 110 may include more than one peripheral interface 140, I/O logic control 150, and/or data converter 160. For example, further peripheral interfaces may include a flash drive interface, a USB interface, a serial port and/or a parallel port.

According to the present invention, the device 100 further includes a camera port 170 disposed on the chip 110. The port 170 may be internal, fully enclosed by the portable device 100, or external, having a portion exposed to the outer environment. As known by those skilled in the art, the camera port 170 is configured to receive first data only from a camera-type arrangement (e.g., a video camera, a photo camera, etc.). The first data may be camera-type data. As known by those skilled in the art, camera-type data typically has a format which consists of pixel information contained on a data bus, combined with a synchronization signal(s) to indicated a line boundary and a frame boundary. The synchronization signal is synchronized to a master pixel clock, and the pixel information indicates the color and intensity of the pixels. Accordingly, the present invention allows the camera port 170 to accept a signal from a data acquisition device (DAD) 180, which may be the camera-type arrangement or a non-camera type arrangement.

The port 170 is configured to receive both the first data from the camera-type arrangement, and second data from the non-camera type DAD 180. The second data is in a format that corresponds to the non-camera type DAD 180, which may not be the same format as the first data from the camera-type arrangement. The second data from the non-camera type DAD 180 may consist of, for example, data representing a real-time signal acquired from the non-camera type DAD 180. The synchronization signal typically found in camera-type data may not be present in the second data, and, thus, the second data may be asynchronous. As would be understood by those skilled in the art, the second data may be generated by photodetectors, scan engines, magnetic head pickups, RF baseband signals, and strain gauges.

As seen in FIG. 1, the DAD 180 is connected to the port 170. In this embodiment, the DAD 180 may be, for example, an undecoded (imager- or laser-based) scan engine. As would be understood by those skilled in the art, the DAD 180 may connect to the port 170 through an external interface (not shown), which is disposed on an outer, environmentally-exposed surface of the DAD 180. As further understood by those skilled in the art, the DAD 180 may be an imager-/laser-based scanner, an RFID reader, a Magstripe reader or other specialized data acquisition device.

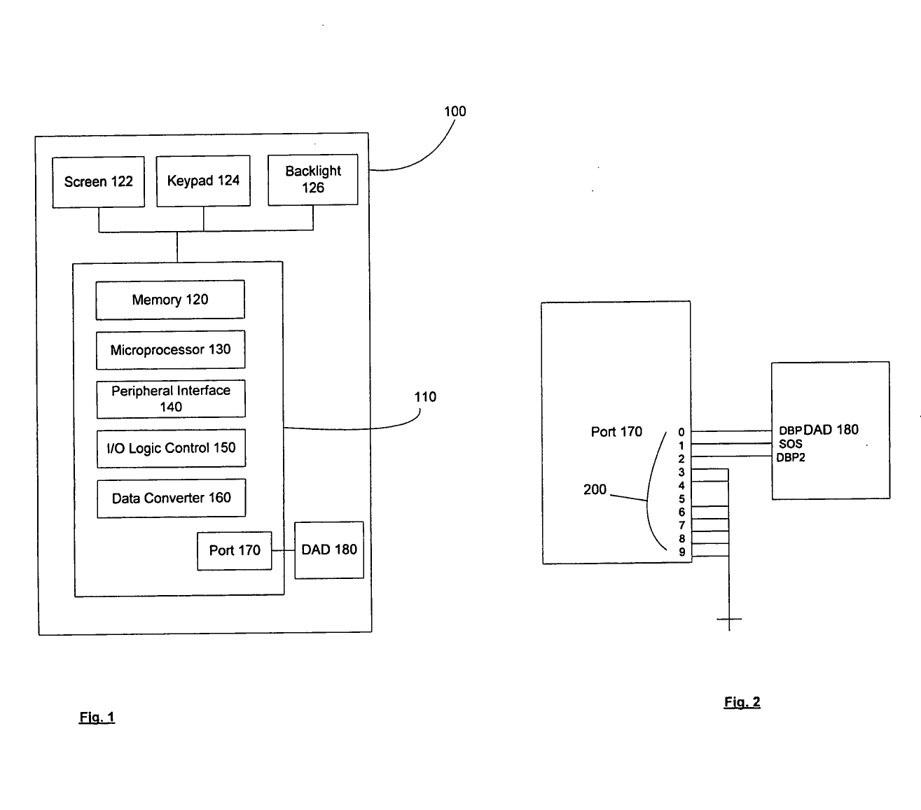

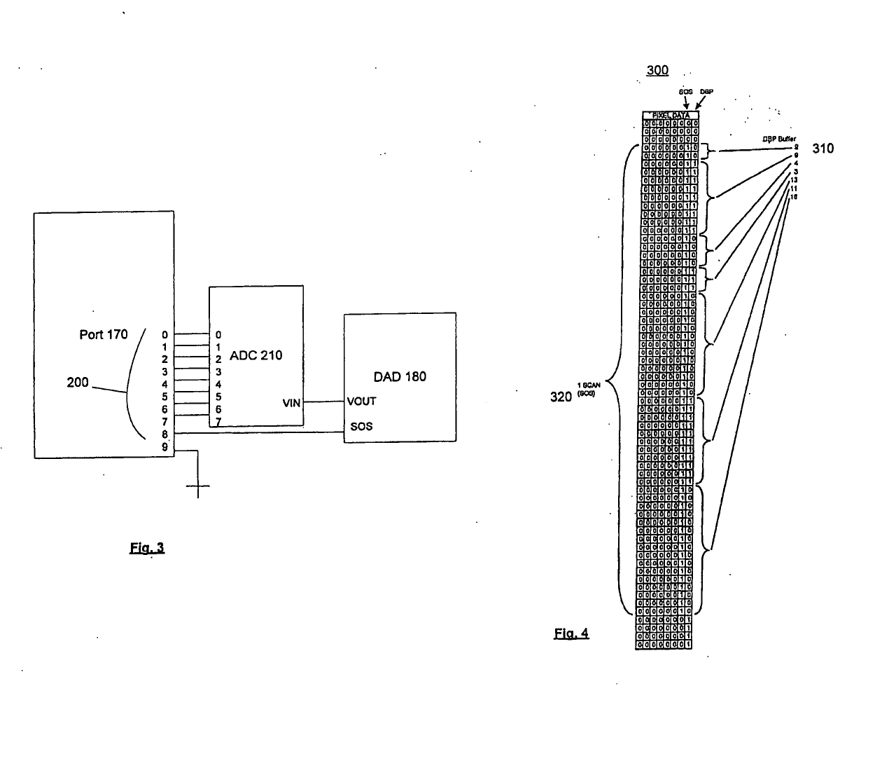

A more detailed view of the connection between the port 170 and the DAD 180 is seen in FIG. 2. The port 170 has a plurality of pins 200 for receiving one or more signals from the DAD 180. In the example of the DAD 180 as the undecoded scan engine, the signal may be a digitized bar pattern (DBP), which represents an image data of a barcode in a digitized form. The signal is sent to the port 170 via the pin 200. The undecoded scan engine may further send a start-of-scan (SOS) signal to the port 170. The undecoded scan engine may send yet a further signal, such as a second DBP, if the scan engine is equipped to run in a dual-DBP mode. As would be understood by those skilled in the art, the DAD 180 may connect directly to the port 170 if the DAD 180 has a digitized output.

The signal from the DAD 180 corresponding to the DBP signal(s) may further include data indicative of an ambient light level in a scanning environment, e.g., across a scan line, a luminance component of an image captured by the DAD 180, etc. As understood by those of skill in the art, the ambient light level may vary depending on a location of a user of the device 100 when the DAD 180 generates the signal. For example, the data in the signal may vary when using the device 100 at night in a shipping yard or in a well-lit warehouse. As will be explained further below, the data indicative of the ambient light level is compared to stored ambient light levels in the memory 120, and settings of components of the device 100 (e.g., brightness of the screen 122) are adjusted accordingly.

The port 170 may be configured to run in a plurality of modes. For example, the port 170 may be configured to run in a non-gated mode, allowing for a user-generated data acquisition timing. For instance, a set of controls (e.g., the keypad 124) may be disposed on the device 100 allowing the user to control the acquisition of data by the DAD 180. Alternatively, the port 170 may be configured to run in a slave mode to map the signals from the DAD 180 as a digital image. As would be understood by those skilled in the art, configuring the port 170 to run in the slave mode and acquire the digital image may be accomplished by setting a blanking interval as short as possible, while setting a pixel per line and a lines per frame as large as possible.

Preferably, the DBP signal(s) and the SOS signal are sampled at a high rate which increases the flexibility of the port 170 in interacting with a variety of DADs. The microprocessor 130 in the processing unit may convert the second data into further second data using a set of instructions in the memory 120, and store the further second data in the format of the first data. As understood by those skilled in the art, in the slave mode, the high sample rate would make the blanking interval minimal. Also, in a preferred embodiment, the signals are transferred by direct memory access (DMA) channels to the memory 120 without passing through the microprocessor 130. As would be understood in the art, using the DMA channels may be advantageous if the acquired data is in a real-time format. However, if the acquired data is a still, photographic image or a laser scan, the acquired data may be sent to the on-chip memory 120 by DMA or through the microprocessor 130.

A further exemplary embodiment of the present invention is shown in FIG. 3. According to this embodiment, the DAD 180 outputs an analog signal to an analog-to-digital converter (ADC) 210. The ADC 210 converts the analog signal from the DAD 180 to a digitized signal, and transfers the digitized signal to the port 170. Preferably, the ADC 210 is an 8-bit ADC so that the analog signal can be sampled at a high rate using the port 170. Furthermore, use of the ADC 210 allows use of a wide range of DADs 180 (e.g., an imager-/laser-based scanner, an RFID reader, a Magstripe reader) to transfer data to the port 170.

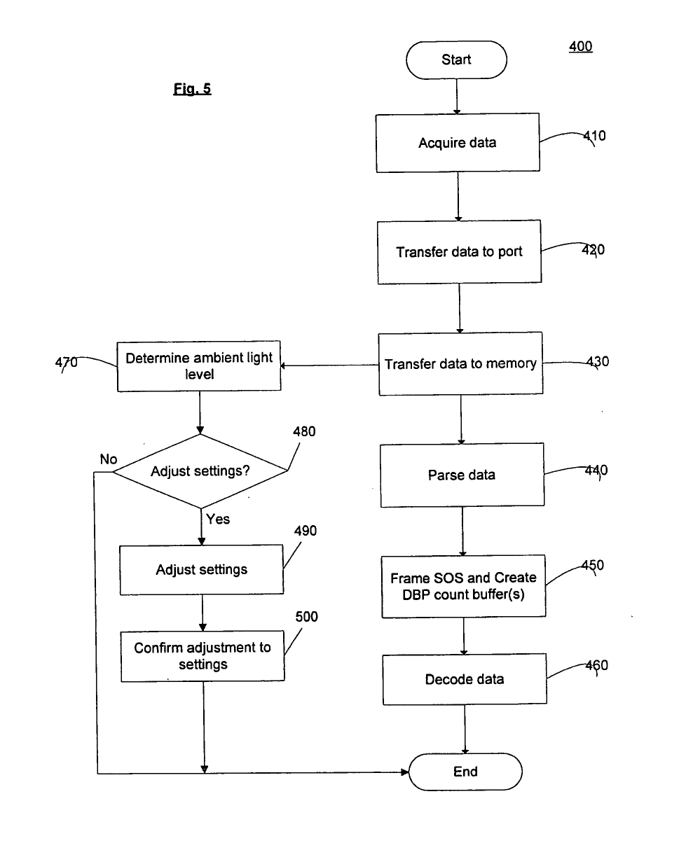

Along with the various hardware configurations discussed above, the present invention further includes a software application shown schematically at 300 in FIG. 4. In the embodiment involving the undecoded scan engine, the SOS signal and the DBP signal(s) are transferred to the on-chip memory 120, and more specifically, the RAM. Also, in this embodiment, a sample of data comprises 8 bits, thereby making the present scheme very flexible, in that the port 170 can acquire data from a wide variety of DADs. The software application 300 parses a raw form of the acquired data and creates a DBP count buffer 310 and an SOS frame 320. The parsed data is then sent to the microprocessor 130 to be decoded by a decoder algorithm. The decoder algorithm may be similar to those typically used and well-known in the art.

As is understood by those skilled in the art, each DAD 180 usable with the present invention may require a unique set of software to parse and decode/process the data. For example, some DADs 180 may use all data points (i.e., binary data in columns in FIG. 4) to decode the signal from the DAD 180, rather than forming the DBP count buffer 310. Other DADs 180 may form the DBP count buffer 310 using other criteria, and then decode/process the data using different algorithms. For example, when sampling the analog data with the ADC 210, a fuzzy logic decoding algorithm may act upon raw, analog sampled data directly. However, the SOS signal would still be sampled digitally to provide the SOS frame 320. Thus, the parsing would monitor the SOS signal to determine the SOS frame 320. Then, all the data from the DAD 180 is sent to the fuzzy logic algorithms.

FIG. 5 shows an exemplary method 400 of acquiring data and detecting an ambient light level according to the present invention. As described above, the exemplary embodiments of the present invention describe, in one instance, a process for acquiring and decoding data from the port 170, and, in another instance, a process for determined an ambient light level and adjusting settings of the device 100 based thereon. The present method will be described as if the DAD 180 is the undecoded scan engine, and the DAD 180 is disposed in an OEM device, such as a cellular phone or PDA. However, those skilled in the art would understand that the undecoded scan engine is simply an illustrative example of the DAD 180 that may be used with the present invention.

In step 410, the DAD 180 acquires data (e.g., the DBP signal) by scanning/imaging a barcode (or any indicia). As described above, the port 170 may be configured to run in a non-gated mode, allowing the user to initiate scans at any time and for any duration. In step 420, the acquired data is transferred to the port 170. As would be understood by those skilled in the art, if the DAD 180 outputs an analog signal, the analog signal may be converted to a digital signal by the ADC 210 before being transferred to the port 170.

In step 430, the acquired data may be transferred from the port 170 directly to the on-chip memory 120 (e.g., the RAM) on the DMA channels. As described above, the acquired data is decoded to obtain data from the barcode. In another exemplary embodiment, the acquired data is utilized to determine the ambient light level and adjust settings of components of the device 100 based thereon. While these processes may be accomplished in parallel as shown in FIG. 5, they may be accomplished in series or be mutually exclusive of each other.

In continuing with the decoding process, the software application 300 parses the acquired data, as indicated by step 440. In step 450, while in the RAM, the software application 300 frames the SOS signal and creates the DBP count buffer(s). In step 460, the parsed data is decoded by the decoder algorithms in the microprocessor 130. As would be understood by those skilled in the art, the method herein described would provide for fuzzy logic decoding within the microprocessor 130. Specifically, sampling the analog signal by the ADC 210 and the port 170 may facilitate fuzzy logic decoding. As further understood, the present invention is flexible enough to utilize advancements in scanning technologies, such as acquiring dual DBPs.

In continuing with the ambient light detection process, the ambient light level is determined as a function of the acquired data, as shown in step 470. The ambient light level may correspond to, for example, intensity of laser light reflected from the barcode or a luminance component of an image of the barcode.

In step 480, the determined ambient light level is compared to stored ambient light levels in the memory 120. For example, the memory 120 may store a table (e.g., light-setting data) comprising a plurality of ambient light levels and settings of the components of the device 100 corresponding to each level. Thus, the device 100 compares the determined ambient light level to the stored ambient light levels in the memory 120 and uses knowledge of a current setting of the components to determine whether the settings of the components should be adjusted. When the determined ambient light level does not indicate that the settings should be changed, the components remain at their current settings.

In step 490, the comparison of the determined ambient light level and the stored ambient light levels indicates that the settings of the components should change. For example, the settings of the components (e.g., brightness of the screen 122, keypad 124, backlight 126, etc.) may have been initialized to a default setting, e.g., maximum brightness. However, when the DAD 180 acquired the data, the device 100 may have been in a naturally and/or artificially well-lit environment. Thus, content on the screen 122 and the keypad 124 may be easily visible without being set to the maximum brightness, which consumes a significant amount of power from a power source (e.g., battery) of the device 100. The acquired data is indicative of an ambient light level corresponding to the well-lit environment, and upon comparison to the stored ambient light levels, the settings of the screen 122, keypad 124 and/or backlight 126 are adjusted, e.g., brightness reduced. In the exemplary embodiment, the brightness may be reduced to a setting corresponding to the stored ambient light level which substantially matches the determined ambient light level. However, those of skill in the art will understand that the settings may be binary (e.g., on or off), and the determined ambient light level may be compared to a threshold value to determine the setting.

In optional step 500, the user of the device 100 may confirm the adjustment to the settings. For example, the settings may be adjusted and a message may be shown on the screen 122 asking the user to confirm the adjustment. Alternatively, the message may be shown on the screen 122 prior to executing the adjustment, at which point the user may authorize or deny the adjustment. For example, if the user is in the well-lit environment and the message indicates that the device 100 is going to change the setting to the maximum brightness, the user may deny the adjustment.

The present invention provides a power-saving scheme for a computing device based on an ambient light level determined from data acquired by the computing device. A setting of one or more components may be adjusted as a function of the ambient light level, reducing consumption of battery power when unnecessary.

The present invention has been described with reference to embodiments that include a microprocessor, a port and a data acquisition device. Different types of data acquisition devices may be accommodated by embodiments of the present invention in addition to the undecoded scan engine described above. Accordingly, various modifications and changes may be made to the embodiments without departing from the broadest spirit and scope of the present invention as set forth in the claims that follow. In particular, other types of data acquisition devices may be used to interact with the port. The specification and drawings are accordingly to be regarded in an illustrative rather than in a restrictive sense.

What is claimed is:

1. A device, comprising:
a processing unit;
a memory arrangement storing setting data, the setting data including a plurality of ambient light levels and a setting of a component of the device corresponding to each level; and
a camera port configured to receive first data in a first format from a camera-type arrangement;
wherein the camera port receives from a non-camera type data acquisition device second data in a second format, the processing unit converting the second data into further second data stored in the first format, and
wherein, the processing unit determines an ambient light level as a function of the further second data and adjusts the setting of the component as a function of the ambient light level and the setting data.

2. The device according to claim 1, further comprising:
an analog-to-digital converter processing data between the camera port and the non-camera type data acquisition device.

3. The device according to claim 1, wherein the non-camera type data acquisition device is one of a laser-based scanner, an image-based scanner, an undecoded scan engine, an RFID reader and a Magstripe reader.

4. The device according to claim 1, wherein the component is one of a display screen, a backlight and a keypad.

5. The device according to claim 1, wherein the setting is a brightness level.

6. The device according to claim 1, wherein the further second data is indicative of one of (i) an intensity of reflected laser light received by the non-camera type data acquisition device and (ii) a luminance component of an image captured by the non-camera type data acquisition device.

7. The device according to claim 1, wherein the camera port transfers the second data to the memory arrangement via a direct memory access.

8. The device according to claim 1, wherein the second data is digitized bar pattern data.

9. The device according to claim 8, wherein the processing unit creates a digitized bar pattern count buffer and a start-of-scan frame to convert the second data into the further second data.

10. The device according to claim 1, wherein the processing unit converts the second data into further second data using a fuzzy logic algorithm.

11. A method for detecting an ambient light level using a camera port on a processor of a computing device, the camera port being configured to receive first data in a first format, comprising:
receiving second data from a non-camera type data acquisition device via the camera port, the second data being stored in a second format;
converting the second data into further second data, the further second data being in the first format;
determining an ambient light level as a function of the further second data; and
adjusting a setting of a component of the device as a function of the ambient light level.

12. The method according to claim 11, further comprising:
comparing the ambient light level to setting data stored in a memory of the device, the setting data including a plurality of ambient light levels and a setting of the component corresponding to each level.

13. The method according to claim 11, wherein the non-camera type data acquisition device is one of an imager-based scanner, a laser-based scanner, an undecoded scan engine, an RFID reader and a Magstripe reader.

14. The method according to claim 11, wherein the component is one of a display screen, a backlight and a keypad.

15. The method according to claim 11, wherein the setting is a brightness level.

16. The method according to claim 11, wherein the further second data is indicative of one of (i) an intensity of reflected laser light received by the non-camera type data acquisition device and (ii) a luminance component of an image captured by the non-camera type data acquisition device.

17. The method according to claim 11, wherein the camera port transfers the second data to the memory arrangement via a direct memory access.

18. The method according to claim 11, wherein the second data is digitized bar pattern data.

19. The method according to claim 18, further comprising:
creating a digitized bar pattern count buffer and a start-of-scan frame to convert the second data into the further second data.

20. The method according to claim 11, further comprising:
converting the second data into further second data with a fuzzy logic algorithm.

21. An arrangement, comprising:
a processing means;
a storage means for storing setting data, the setting data including a plurality of ambient light levels and a setting of a component of the device corresponding to each level; and
a camera interface means for receiving first data in a first format from a camera-type arrangement;
wherein the camera interface means receives from a non-camera type data acquisition device second data in a second format, the processing means converting the second data into further second data stored in the first format, and
wherein, the processing means determines an ambient light level as a function of the further second data and adjusts a setting of the component of the arrangement as a function of the ambient light level and the setting data.
